(19) United States
(12) Patent Application Publication
(10) Pub. No.: US 2025/0370457 A1
(43) Pub. Date: Dec. 4, 2025

(54) Method for simultaneous localization and mapping; associated system and computer program

(71) Applicant: THALES, Meudon (FR)

(72) Inventors: Pierre-Jean AUILLANS, MERIGNAC (FR); Mohamed TAHIRI, MERIGNAC (FR); Siegfried ROUZES, MERIGNAC (FR)

(21) Appl. No.: 19/220,080

(22) Filed: May 28, 2025

(30) Foreign Application Priority Data
Jun. 4, 2024 (FR) 2405838

(51) Int. Cl. G05D 1/246; G01S 13/28; G01S 13/53; G01S 13/89; G05D 109/25; G05D 111/30; G05D 111/50

(52) U.S. Cl. CPC G05D 1/246; G01S 13/282; G01S 13/53; G01S 13/89; G05D 2109/25; G05D 2111/30; G05D 2111/52

(57) ABSTRACT

A method carried out by an on-board calculator on a vehicle, including acquiring a set of points at the current time, delivered by a Doppler radar system of the vehicle, acquiring the attitude of the vehicle at the current time, delivered by a vehicle inertial navigation system, orienting the set of points at the current time with respect to a land reference frame taking into account the attitude at the current time, processing the radial speeds of the points to calculate an estimated speed of the vehicle at the current time, calculating a position of the vehicle at the current time from the estimated speed at the current time, and executing a simultaneous localization and mapping algorithm based on the position of the vehicle at the current time over a plurality of successive times.

### REFERENCE TO RELATED APPLICATION

This application is a U.S. non-provisional application claiming the benefit of French Patent Application No. 24 05838 filed on Jun. 4, 2024, the contents of which are incorporated herein by reference in their entirety.

### TECHNICAL FIELD OF THE INVENTION

The field of the invention is that of autonomous navigation of a vehicle, be it an aircraft, a car, a robot, etc.

More specifically, the invention relates to methods, implemented by computer in real time, consisting of executing an algorithm of the simultaneous localization and mapping type. These algorithms are often referred to by the acronym SLAM. The algorithm CML is also encountered, which stands for “Concurrent Mapping and Localization”.

### BACKGROUND OF THE INVENTION

For an autonomous vehicle, a SLAM algorithm consists of building or improving a map of the environment in which the vehicle is moving and simultaneously locating the vehicle within that map.

The mapping corresponds to a virtual reconstruction of the environment, in two or three dimensions, from points detected in the environment by means of a detection device on board the vehicle, such as Lidar, one or more cameras, or the equivalent.

Since the detection device is on-board, a model of the vehicle's movement is used to relocate the detected points from a moving reference point attached to the vehicle, to a terrain reference point, which is a fixed reference point, attached to the environment. Advantageously, this model can be informed by the outputs of a positioning device on board the vehicle, such as an inertial navigation system, one or more odometry sensors, or the equivalent.

The correlations that can be established between the positions of points detected at the current time and those of points detected in the past (taking into account the movement of the vehicle given by the movement model) make it possible not only to improve the mapping of the environment, but also to improve the vehicle movement model, so that the model gives the instantaneous positioning of the vehicle (consisting of three position coordinates and three orientation coordinates of the vehicle, when the vehicle is moving) with precision.

A SLAM algorithm enables a vehicle to navigate an initially unfamiliar environment that it gradually discovers.

In particular, this navigation is advantageously carried out autonomously, i.e., without the need to use means external to the vehicle, such as a Global Navigation Satellite System (GNSS) to determine its instantaneous position.

For example, the implementation of a SLAM algorithm is adapted to the following use case.

To land on an unmarked runway, a helicopter pilot must first fly over the potential landing area to visually assess the surrounding obstacles (trees, power lines, etc.) and the slope of the landing area (or gradient).

This preparatory phase can take a long time. A 360° view of the landing area can take around three minutes.

The use of a process such as simultaneous localization and mapping should make it possible to automate this preparatory phase.

However, it must be possible to carry out this phase under poor visual conditions, whether due to the general weather conditions of the flight (rain, fog, darkness, etc.) or the nature of the terrain in the landing area, which, as the helicopter approaches, might raise a cloud of dust, sand, snow, etc.

The challenge is therefore to obtain an accurate map of the environment in real time, whatever the visual conditions, and to locate the vehicle precisely within this map, without having to use a satellite positioning system.

### SUMMARY OF THE INVENTION

The purpose of this invention is to solve this problem.

A first aspect of the invention is therefore a method of simultaneous localization and mapping, implemented by a calculator of an on-board system in a vehicle, the system being equipped with an inertial navigation system and a Doppler radar system, characterized in that the method includes the steps of: acquiring a set of points at the current time delivered by the Doppler radar system, one point of the set of points being characterized by a position and a radial speed in a moving reference frame associated with the vehicle, acquiring the attitude of the vehicle at the current time, delivered by the inertial navigation system, orientating the points of the set of points at the current time with respect to a fixed land reference frame, taking account of the attitude at current time, processing the radial velocities of the points in the set of points at the current time in order to calculate an estimated speed of the vehicle at the current time, calculating a position of the vehicle at the current time, taking into account the estimated speed of the vehicle at the current time, and executing a simultaneous localization and mapping algorithm, taking account of the position of the vehicle at the current time, over a plurality of successive times.

A second aspect of the invention relates to a system adapted to implement a method of simultaneous localization and mapping in accordance with the preceding method, the system including a Doppler radar system, an inertial navigation system, and a suitably programmed calculator.

A third aspect of the invention relates to a computer program product including software instructions which, when executed by the calculator of a system conforming to the preceding system, makes it possible to implement all or some of the steps of a simultaneous locating and mapping method conforming to the preceding method.

### BRIEF DESCRIPTION OF THE DRAWINGS

The invention and its advantages will be better understood upon reading the following description of a particular embodiment, given only as an example, and with reference to the attached drawings, in which:

FIG. 1 illustrates a particular use case of the method and system according to the invention;

FIG. 2 is a schematic depiction in the form of functional modules of one embodiment of a system according to the invention; and

FIG. 3 is a schematic block depiction of one embodiment of the identification method according to the invention.

### DETAILED DESCRIPTION OF THE INVENTION

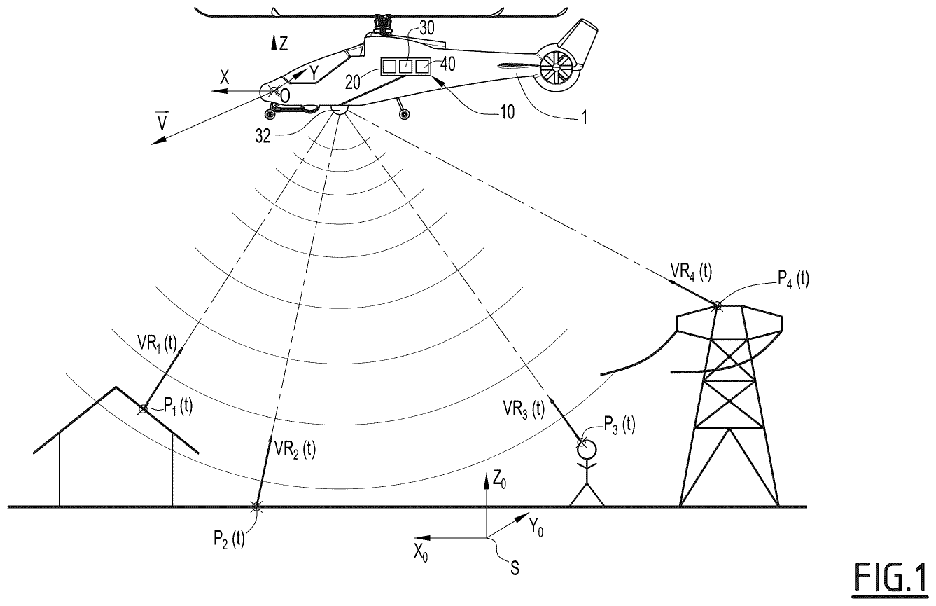

FIG. 1 illustrates a particular use case for the system 10 and method 100 according to the invention.

In this use case, the system 10 according to the invention is carried on board a helicopter 1, as a particular example of an autonomous vehicle adapted to move along three axes. The particular case of an aircraft, and more particularly a helicopter, is used to describe the invention, but the invention may be applied to any type of vehicle, either to assist the pilot of this vehicle, or to pilot the vehicle automatically.

A moving reference frame is associated with the helicopter 1. It is marked by the X, Y and Z axes in FIG. 1. This moving reference frame is attached to a point O on the helicopter 1.

The helicopter has an instantaneous vector speed \vec{V}(t).

The system 10 includes an inertial navigation system 20, a Doppler radar system 30 and a calculator 40.

The system 30 includes an antenna 32 and hardware and software resources associated with the operation of this antenna.

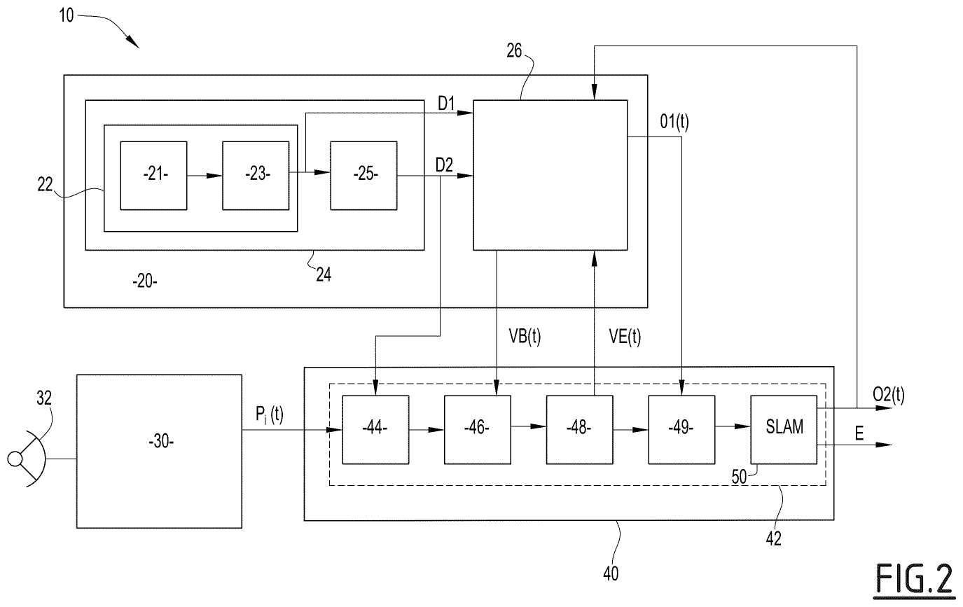

These different components of the system 10 will be presented in detail below with reference to FIG. 2.

Periodically, the radar system 30 scans an area of observation located within the environment of the helicopter 1. This area of observation covers, for example, all or part of an area of interest on the ground, such as a potential landing area.

A reference frame, fixed to the ground, or land reference frame is marked by the X₀, Y₀ and Z₀ axes in FIG. 1. This land reference frame is attached to a point S in the environment.

For each period of its operation, the radar system 30 delivers a set of points. For example, in FIG. 1 and for the current time t, there is shown a point P₁(t) associated with a building, a point P₂(t) associated with the ground itself, a point P₃(t) associated with an individual moving on the surface of the ground, and a point P₄(t) associated with a structural element, such as an electricity pylon.

A point Pᵢ (i being an integer between 1 and N(t), where N(t) is the total number of points in the set of points delivered by the radar 30 at time t) is associated with an object or a portion of an object that has reflected an echo after being “illuminated” by the radar system 30.

A point Pᵢ is characterized by a distance from the antenna 32 of the radar system 30. Knowing the direction in which the echo was received, the radar system 30 determines the position of the point Pᵢ in the moving reference frame XYZ.

As the radar system 30 is a Doppler radar system, it is adapted to process a received echo so as to measure its Doppler speed. The

Doppler speed is a radial speed, i.e., the projection of the instantaneous speed of the reflecting object onto the direction joining the radar system 30 and the reflecting object (the point Pᵢ(t) source of the echo). This speed is denoted VRᵢ(t) in FIG. 1. It is evaluated in the mobile frame XYZ.

A particular embodiment of the system 10 will now be presented in relation to FIG. 2.

The system 10 incorporates a Doppler radar system 30. Advantageously, this is a Commercial Off-The-Shelf (COTS) Doppler radar system.

Preferably, the Doppler radar system 30 is a Frequency Modulated Continuous Wave (FMCW) radar. By transmitting a frequency-modulated continuous wave, the echo reflected by an object in the environment is processed, in the frequency domain, to obtain the distance separating the radar from the reflecting object along the pointing direction of the radar at the time the echo is received, as well as the Doppler speed of this reflecting object.

The position and radial speed of an echo constitute the output data of the Doppler radar system 30. The position may be a position in radial coordinates (direction and distance along this direction) or in Cartesian coordinates (position along the three axes of the moving reference frame) in the moving reference frame.

Other outputs may also be associated with a point, such as the echo amplitude.

Assuming a time interval allowing the Doppler radar system 30 to scan its area of observation once, a set of points is delivered by the Doppler radar at each scanning period. In the following, the scanning period is taken as the elementary period for implementing the method 100. In particular, “instantaneous” means a value of a physical quantity obtained for the current elementary period.

The system 10 incorporates an inertial navigation system (INS) 20. Advantageously, this is a Commercial Off-The-Shelf (COTS) inertial navigation system.

Generally speaking, an inertial navigation system 20 may be described as including an IMU (Inertial Measurement Unit) 22. This incorporates a set of sensors 21, in particular accelerometers and gyroscopes, and associated electronics 23, enabling the signals delivered by the sensors 21 to be processed and a first set of data D1 to be generated.

This first set of data D1 corresponds to the linear acceleration along the three axes of the land reference frame X₀Y₀Z₀ and the instantaneous rotation speeds around each of these axes.

The inertial navigation system 20 includes an Attitude Heading Reference System (AHRS) 24. The system 24 associates an attitude calculator 25 with the IMU 22. The attitude calculator 25 takes as its input the first set of data D1, supplied by the IMU 22, and calculates as its output a second set of data D2.

This second set of data D2 includes the instantaneous attitude of the aircraft relative to the land reference frame. Attitude is characterized by three angles: heading (i.e., the angle between the longitudinal axis of the vehicle and the direction of the magnetic or geographical pole), attitude (i.e., the angle between the longitudinal axis of the vehicle and a horizontal plane) and inclination (i.e., the angle between the transverse axis and a horizontal plane).

Finally, the inertial navigation system 20 combines the AHRS system 24 with a navigation calculator 26. The navigation calculator 26 takes as input the first and second data sets, D1 and D2, and calculates as output a third data set.

This third data set includes an instantaneous speed of the aircraft VB(t) and an instantaneous position of the aircraft relative to the land reference frame, O1(t).

The system 10 incorporates a calculator 40, which is connected, on the one hand, to the output of the radar system 30 and, on the other hand, to the input and output of the inertial navigation system 20.

The calculator 40 is a computer including computing means, such as a processor, and information storage means, such as a memory.

In particular, the memory stores the instructions of a computer program 42, the execution of which enables the method 100 according to the invention to be implemented.

Schematically, in the preferred embodiment, the program 42 may be described as including an orientation module 44, a filter module 46, a module for calculating the instantaneous speed of the aircraft relative to the ground 48, a georeferencing module 49 and a SLAM module 50.

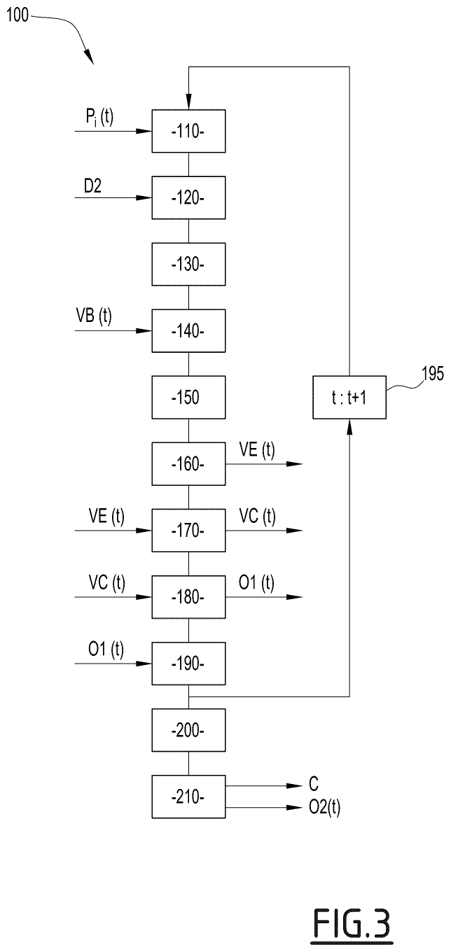

A preferred embodiment of the method according to the invention will now be described with reference to FIG. 3.

The method 100 begins with a step 110 in which the calculator 40 acquires the data delivered by the Doppler radar system 30. It periodically provides the results of a scan of its field of observation. The data delivered by the radar system 30 at the current time corresponds to a set of points. Each point Pᵢ(t) in this assembly is associated with a position and a radial speed, these quantities being evaluated in the aircraft's XYZ moving reference frame at the current time t.

The method 100 continues with a step 120 in which the calculator 40 acquires the second set of data D2 delivered at the current time t by the AHRS unit 24 of the inertial navigation system 20. This data is the attitude of aircraft 1 at the current time, i.e., the direction of axes XYZ relative to land reference frame X₀Y₀Z₀.

In a step 130, corresponding to the execution of the orientation module 44 by the calculator 40, each point of the set of points obtained in step 110 is orientated correctly in the land reference frame, taking into account the instantaneous attitude obtained in step 120. The attitude at the current time makes it possible to orientate the moving reference frame relative to the land reference frame (by means of a rigid transformation between the antenna of the radar system 30 and the inertial navigation system 20, the parameters of which are known, following a prior calibration step of the system 10, for example).

Following the performance, by the navigation calculator 26 of the inertial navigation system 20, of a first time integration of the data delivered by the units 22 and 24, making it possible to determine a first instantaneous speed of the aircraft in the land reference frame, this speed is acquired by the calculator 40 in step 140 as the instantaneous raw speed VB(t).

Step 150, corresponding to the execution of module 46 by the calculator 40, consists of filtering the radial velocities of the points in the set of points obtained in step 110 and suitably oriented in step 130.

Some of the points in this set of points correspond to fixed objects on the ground. Their radial speed is related to the instantaneous speed of the vehicle relative to the ground, i.e., the speed of the mobile reference frame relative to the land reference frame. It is the information carried by these fixed points that is relevant to the rest of the method 100.

However, in addition to these fixed points, the set of points at the current time may further include points that correspond to objects that move relative to the ground, such as a tree moving in the wind, a person moving, a car driving, etc.

The filtering step 150 then consists of extracting the moving points from the set of points Pᵢ(t) so that their radial speed, which is specific to them, does not interfere with the rest of the method 100.

To separate the moving points from the fixed points in the set of points at the current time, a filter speed is taken into account, which corresponds to the instantaneous speed of the aircraft 1 relative to the ground.

To determine whether a point is fixed or moving, we need to take into account not only the value of the radial speed of this point, but also the direction along which this radial speed is evaluated, i.e., the direction between the radar system and the point in question. In fact, the radial speed of a fixed point located along a direction parallel to that of the vehicle speed is substantially equal to the instantaneous speed of the aircraft (negative radial speed for a point located in front of the aircraft and positive for a point to the rear of the aircraft, the front and rear being evaluated along the direction of the instantaneous speed of the aircraft). In contrast, the radial speed of a fixed point located along a direction orthogonal to that of the aircraft's speed is substantially zero.

Advantageously, this filtering step is performed by assuming that the instantaneous speed of the vehicle is equal to the instantaneous raw speed VB(t) acquired in step 140.

Advantageously, the points are filtered taking into account an uncertainty in the value of the filtering speed.

Alternatively, step 140 is not performed, and the instantaneous speed of the vehicle around which filtering is performed is estimated by suitable processing, for example statistical processing, of the radial speeds and positions of the points in the set of points at the current time.

Step 150 thus makes it possible to obtain a subset of points corresponding to fixed objects on the ground.

Only the subset of fixed points is used in the rest of the method 100. However, the complementary subset corresponding to points associated with moving objects may be used in other processing, such as an algorithm for detecting the presence of a person in the planned area for landing the helicopter, which sends an alarm, for example an audible alarm, to the pilot if the presence of a person in this area is detected.

The next step 160 in the method 100 consists of calculating a second instantaneous speed of the aircraft 1 VE(t) from the radial speeds of the points in the subset of fixed points. The step 160 corresponds to the execution of the module 48 by the calculator 40.

Algorithms are known, such as those used in a Janus system, which, based on the radial speed associated with at least four fixed points in as many different directions, make it possible to estimate the carrier's speed. Advantageously, all the fixed points at the current time are used by performing a least-squares regression.

Thus, at the end of step 160, an instantaneous estimated speed VE(t) of the aircraft in the land reference frame is obtained.

The step 180 consists in the navigation calculator 26 of the inertial navigation system 20 determining the instantaneous position O1(t) of the aircraft 1 from its instantaneous speed by performing a time integration.

In a simple embodiment, the speed integrated in the step 180 is the instantaneous estimated speed VE(t) obtained directly at the output of the step 160.

Preferably, however, the instantaneous estimated speed VE(t) at the output of the step 160 is applied as an input to the navigation calculator 26 of the inertial navigation system 20, for example as a variable enabling the instantaneous speed calculated by the navigation calculator of the inertial navigation system to be recalibrated, to prevent it from drifting.

In step 170, the instantaneous raw speed VB(t) obtained in step 140 is corrected, taking into account the instantaneous estimated speed VE(t) obtained in step 160.

An instantaneous corrected speed VC(t) is thus determined at the end of step 170. It is this corrected magnitude which is applied as the input to step 180 in order to be integrated over time and thus obtain the instantaneous position O1(t) of the vehicle in the land reference frame.

This method is particularly advantageous as it enables the algorithms implemented by the navigation calculator 26 of the inertial navigation system to be reused, in particular the “Kalman filter” type algorithms generally executed by the navigation calculators of inertial navigation systems.

The instantaneous position of the vehicle O1(t) is then used, in a step 190 corresponding to the execution of module 49, to georeference the points in the set of points at the current time; the fixed points, but preferably the moving points too.

Then, following the iteration (step 195) of steps 110 to 190 over a succession of instants (and therefore a set of points), in a step 200, a SLAM algorithm is executed.

For example, the last five sets of points acquired and processed by steps 110 to 180 are taken into account when the SLAM algorithm is run.

The step 200 corresponds to the execution of the module 50 by the calculator 40. For example, this is a SLAM algorithm of the ICP (Iterative Closest Point) type.

In this way, the point clouds acquired during each period of operation of the radar system 30 may be used to reconstruct the three-dimensional environment within which the helicopter 1 is moving.

Advantageously, when the SLAM algorithm matches points between two point clouds acquired at different times, it not only corrects the position of the map points, but also the instantaneous position of the vehicle (step 210). Thus a particularly accurate corrected instantaneous position O2(t) of the aircraft 1 is obtained at the output of step 210 in addition to the accurate mapping of the environment C.

Advantageously, this instantaneous corrected position O2(t) is used in step 180. For example, when step 180 is performed by the navigation calculator of the inertial navigation system, the corrected instantaneous position delivered by the SLAM algorithm is used to realign the inertial navigation system.

In this way, the present invention avoids the double time integration normally carried out by the navigation calculator of an inertial navigation system, when the latter calculates the instantaneous position from the measurements made by the IMU sensors alone. In other words, the present invention avoids the rapid time drift on the value of the instantaneous position calculated by an inertial navigation system according to the prior art, or at least the time drift of a low-cost inertial navigation system.

With the implementation of the invention, the instantaneous position is obtained by performing a single integration of the instantaneous speed, whether this is the speed estimated using only data associated with the point clouds delivered by the radar system, or whether it is the speed corrected by the inertial navigation system by taking account of the speed estimated by processing the data associated with the point clouds delivered by the radar system.

In addition, the present invention avoids rapid time drift on the value of the instantaneous position calculated by an inertial navigation system according to the state of the art by constraining the calculation of the instantaneous position carried out by the inertial navigation system using the instantaneous position obtained at the output of the SLAM algorithm.

Although radar has a lower spatial resolution than Lidar or an optical camera, it operates in a wide range of visual conditions, including poor or very poor visual conditions.

By merging the data supplied by a radar system and an inertial measurement system, the method according to the invention makes it possible to achieve a high level of accuracy.

Standard off-the-shelf components may then be used, particularly low-cost components, each of which has reduced accuracy.

The invention is particularly well suited to drone aircraft, especially for autonomous landings. But it has other applications, particularly for autonomous vehicles such as moving robots travelling around a hangar.

Step 150, relative to filtering the points to separate fixed and moving points, is optional. It is better to implement it to gain accuracy.

Alternatively, however, it is possible to evaluate the velocity VE(t) from the complete set of points, using a statistical procedure for example. In this case, although the moving points degrade the statistics, it is possible to assume that the points are only slightly mobile relative to the carrier and/or that the average speed of the subset of points that are mobile relative to the carrier is zero.

1. A method for simultaneous localization and mapping, comprising:
for each of a plurality of successive times:
acquiring a set of points at a current time, the set of points being delivered by a Doppler radar system, a point of the set of points being characterized by a position and a radial speed in a moving reference frame associated with the vehicle;
acquiring an attitude of the vehicle at the current time, the attitude being supplied by an inertial navigation system;
orientating the points of the set of points relative to a fixed land reference frame, taking into account the attitude;
processing the radial speed of points of the set of points in order to calculate an estimated speed of the vehicle at the current time; and
calculating a position of the vehicle at the current time, taking into account the estimated speed of the vehicle; and
executing a simultaneous localization and mapping algorithm taking into account the position of the vehicle over the plurality of successive times.

2. The method according to claim 1, further comprising filtering the set of points to retain only the points corresponding to objects that are fixed relative to the land reference frame.

3. The method according to claim 2, wherein said filtering takes into account a raw speed at the current time of the vehicle delivered by the inertial navigation system.

4. The method according to claim 1, wherein said calculating takes into account only the estimated speed of the vehicle.

5. The method according to claim 3, comprising correcting the raw speed by taking into account the estimated speed so as to obtain a corrected speed at the current time of the vehicle, and wherein said calculating is carried out on the basis of the corrected speed.

6. A system comprising:
a Doppler radar system;
an inertial navigation system; and
a calculator suitably programmed,
wherein the system implements the method according to claim 1.

7. The system according to claim 6, wherein said Doppler radar system is of a frequency-modulated continuous wave radar type.

8. The system according to claim 6, wherein said calculator implements a simultaneous localization and mapping algorithm of the iterative closest point type.

9. A non-transitory computer readable medium comprising instructions stored thereon, the instructions, when executed by a computer, cause the computer to execute the method according to claim 1.
